(19) United States
(12) Patent Application Publication
(10) Pub. No.: US 2017/0086605 A1
(43) Pub. Date: Mar. 30, 2017

(54) WEIGHTED BEACH TOWEL WITH INTEGRATED SOUND SYSTEM

(71) Applicant: Ryan Wolfe, Orlando, FL (US)

(72) Inventor: Ryan Wolfe, Orlando, FL (US)

(21) Appl. No.: 14/870,094

(22) Filed: Sep. 30, 2015

(51) Int. Cl. A47G 9/06; H04R 3/12; H04R 1/02

(52) U.S. Cl. CPC A47G 9/062; H04R 1/028; H04R 3/12

(57) ABSTRACT

A weighted beach towel with an integrated sound system includes a main towel body having a soft top surface, a waterproof bottom surface and a plurality of sides defining four corners. Weighted elements are located within pockets along the bottom corners of the main body, and a sound system having a communication unit, a speaker and a user control unit are disposed within a pocket located along one of the upper corners of the main body. The communication unit can wirelessly or physically engage an external media player to receive an audio file for playback on the speaker. A second speaker is disposed within a pocket located along the other upper corner of the main body.

### TECHNICAL FIELD

The present invention relates generally to beach articles, and more particularly to a beach towel having an integrated sound system.

### BACKGROUND

The statements in this section merely provide background information related to the present disclosure and may not constitute prior art.

Beach towels, picnic blankets and other such mats are a necessary item for many outdoor activities. To this end, these items are utilized extensively at beaches and other such locations where chairs or loungers are not readily available. As such, beach towels are typically placed onto the sand where they provide a clean and comfortable surface for relaxation, sunbathing and/or picnicking.

Although these items work well on calm days, they suffer from several drawbacks if they are used in a windy environment, as is often the case at the beach. To this end, one of the biggest complaints about beach towels is that they can be easily blown over, thereby allowing sand to accumulate on the surface of the towel. In response, users must often place their personal items along the corners of their towel(s), as opposed to keeping such items at a more convenient location.

One such item that often accompanies a beach towel is a music device such as a radio or MP3 player, for example. Unfortunately, such music devices typically include delicate electronics that do not lend themselves to wet and sandy conditions. As such, users must take care to ensure these items remain clean and dry, so as to prolong the life of the same.

Accordingly, it would be beneficial to provide a weighted beach towel having an integrated sound system that is adapted for use in wet sandy conditions, so as to not suffer from the drawbacks of the above noted devices.

### SUMMARY OF THE INVENTION

The present invention is directed to a weighted beach towel with an integrated sound system. One embodiment of the present invention can include a main towel body having a soft top surface and a plurality of sides defining four corners. Weighted elements can be located within pockets along the bottom corners of the main body. In one embodiment, a sound system having a communication unit, a speaker and a user control unit can be disposed within a pocket located along one of the upper corners of the main body. The sound system can engage an external media player such as a smartphone, MP3 player or IPod®, for example.

In another embodiment, a second speaker can be disposed within a pocket located along the other upper corner of the main body. Each of the speakers can play audio files from the external media device. A communication cable can physically secure the sound system to the external media device, and a cable input can link multiple towels together to play audio files from the external device.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a plan view of a weighted beach towel with integrated sound system that is useful for understanding the inventive concepts disclosed herein.

FIG. 2 is a simplified block diagram of the sound system of the beach towel device, in accordance with one embodiment of the invention.

FIG. 3 is a perspective view of the weighted beach towel with integrated sound system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured,” and derivatives thereof shall be used to describe a situation wherein two or more objects are joined together in a non-permanent manner so as to allow the same objects to be repeatedly joined and separated.

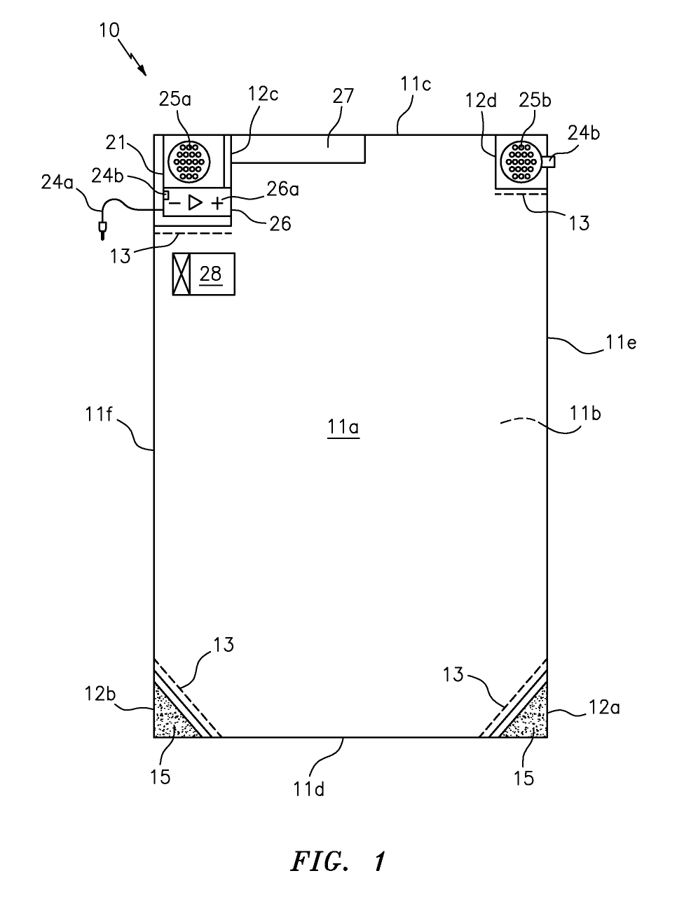

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-3 illustrate one embodiment of a weighted beach towel with integrated sound system 10 that is useful for understanding the inventive concepts disclosed herein. As shown, the towel can include, essentially, a main body 11 having a plurality of weighted elements 15, and a sound system 20 disposed therein.

The main body can function to provide a soft and comfortable place for a user to rest. As shown in FIG. 1, the main towel body 11 can include a substantially rectangular shape having a top surface 11a and a bottom surface 11b. The towel body can include a single layer of material, or the top and bottom surfaces can comprise two substantially identically shaped materials that are joined together via a seam connector such as sewed stitches, for example, along the top end 11c, the bottom end 11d and the pair of opposing sides 11e and 11f.

The top surface 11a of the towel body will preferably be constructed from a soft and absorbent material such as cotton, for example, and the bottom surface 11b can preferably be constructed from a lightweight waterproof material such as waterproof polyester or rayon, for example. Of course, any number of different materials capable of being repeatedly sent through a conventional washing machine and dryer are also contemplated. Although not illustrated, other embodiments of the device are contemplated wherein padding can be disposed between the top and bottom surfaces of the towel body. When so included, the towel can be essentially transformed into a beach blanket.

A pair of generally resilient weighted elements 15 can be positioned within pockets 12a and 12b located at the bottom corners of the main body 11. In one embodiment, each of the weighted elements can comprise, essentially, all weather bean bags that are filled with EPS beads, for example, and having a weight of between approximately 0.25 pounds and 0.75 pounds each. Of course, any number of other weights and materials such as EPP beads, micro-beads and/or natural fillers such as beans, rice and corn, for example, are also contemplated. In either instance, the pockets can be secured closed via a connector 13 in either a permanent fashion via stitching or seam adhesives, or in a removable fashion via snaps, buttons, zippers and/or strips of hook and loop material, for example.

Although dimensions are not critical, in the preferred embodiment the towel body can include a length (e.g., distance between top end 11c to bottom end 11d) of approximately 72 inches, and a width (e.g., distance between sides 11e and 11d) of approximately 40 inches. Of course any number of other dimensions are also contemplated. Moreover, although illustrated and described as including a generally rectangular shape, this is not required, as the towel device can include an unlimited number of different shapes such as round or oval, for example.

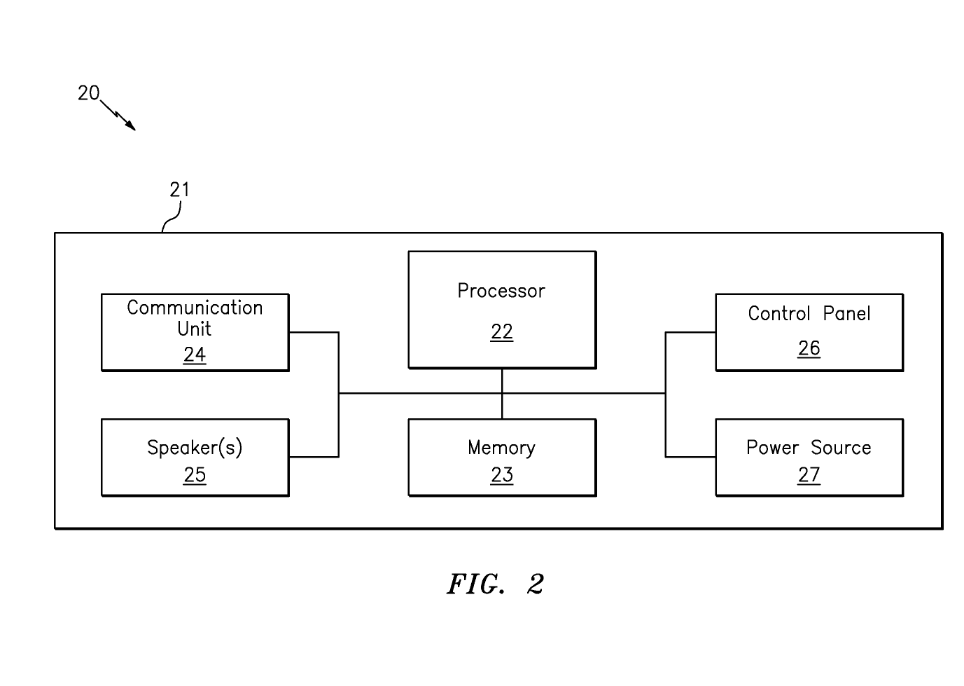

The sound system 20 can communicate with any number of external media players, such as a smartphone, MP3 player or IPod®, for example, so as to receive, store and/or play audio files via the integrated speakers. As shown best in FIG. 2, the sound system can include a component housing 21 having a processor 22 that is conventionally connected to an internal memory 23, a communication unit 24, one or more speakers 25, a user control panel 26, and a power source 27.

Although illustrated as separate elements, those of skill in the art will recognize that one or more system components may be, or include one or more printed circuit boards (PCB) containing an integrated circuit or circuits for completing the activities described herein. The CPU may be one or more integrated circuits having firmware for causing the circuitry to complete the activities described herein. Of course, any number of other components capable of performing the below described functionality can be provided in place of, or in conjunction with the below described controller elements.

The component body 21 can house each of the elements 22, 23, 24 25a, and 27 in a conventional manner, so as to create a single device. In this regard, the main body 21 can take any number of different shapes and sizes, and can be constructed from any number of different materials and methods. In one preferred embodiment, the main body 21 can be constructed from lightweight injection molded plastic forming a watertight shell for protecting the internal components from moisture and other adverse elements. Of course, any number of other waterproof construction materials such as PVC and composites, for example, are also contemplated.

The processor/CPU 22 can act to execute program code stored in the memory 23 in order to allow the device to perform the functionality described herein. Memory 23 can act to store operating instructions in the form of program code for the processor 22 to execute. Although illustrated in FIG. 2 as a single component, memory 23 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. To this end, the bulk storage device can function to receive and store audio files from an external media player for playback by the integrated speakers without requiring the external media player to be attached thereto.

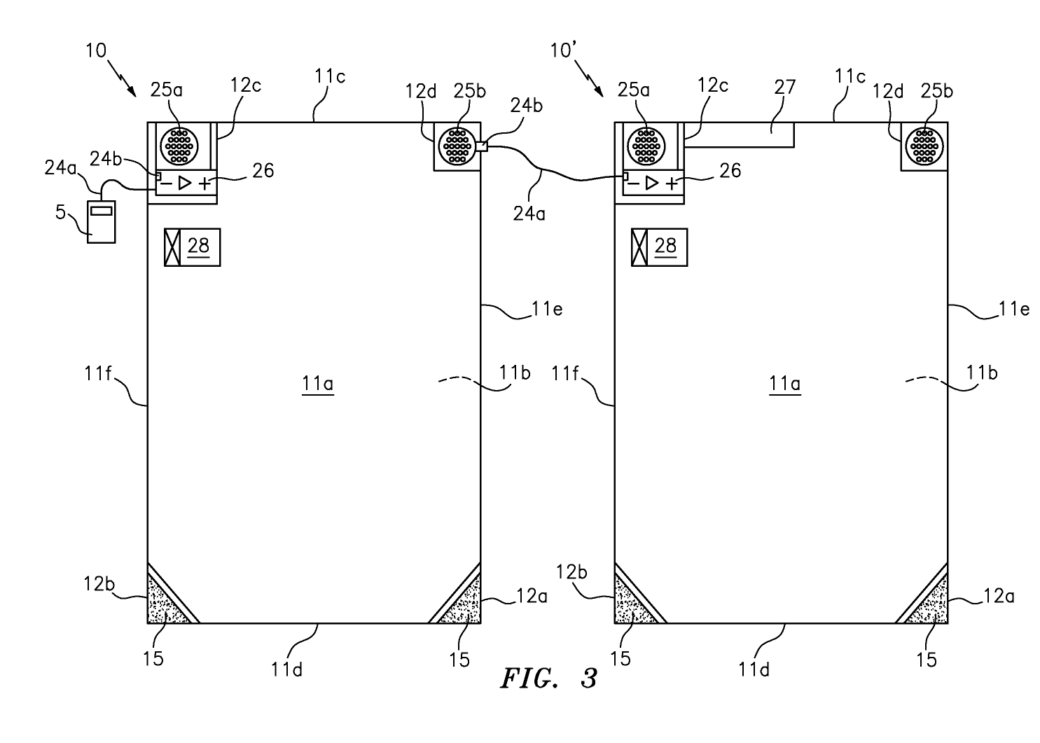

The communication unit 24 can include any number of devices capable of communicating with an external media player either directly or over a network. In one embodiment, the communication unit can include a communication cable 24a such as an audio cable, or USB cable, for example, which can provide a direct communicative link between the system 20 and the external device. Additionally, the device can include one or more cable inputs 24b, which can allow the communication cable(s) 24a of multiple devices 10 to be linked together, and controlled by a single media device (See FIG. 3). In addition to the above, the communication unit 24 can also include or comprise a wireless communication element such as a Bluetooth transceiver, for example, that is capable of communicating wirelessly with any number of external devices.

One or more waterproof speakers 25 can be communicatively linked to the processor so as to receive and play the audio signals received from the external device. In the preferred embodiment, the housing 21 and a first speaker 25a can be secured within pocket 12c, and a second speaker 25b having another cable input 24b connected thereto can be secured within pocket 12d, located along the top end of the main body. Each of the pockets 12c and 12d will also include connectors 13 such as strips of hook and loop material, for example, which can allow the speakers components to be removed when the main body 11 is laundered. Of course, other embodiments are also contemplated wherein the housing and/or speakers are permanently located within the pockets 12c and 12d, and are constructed to withstand being washed and dried in a commercially available washing machine and dryer.

A user control panel 26 can be positioned along the outside of the housing 21. The control panel can include any number of buttons 26a, switches and the like, so as to accept user inputs and provide instructions to the processor. Several nonlimiting examples of suitable instructions which can be carried out by the control panel 26 include, but are not limited to, play, pause, rewind, fast forward, wireless pairing and power, for example. Of course, any number of other commands are also contemplated.

In one preferred embodiment, the power source 27 can include one or more DC coin batteries capable of providing the necessary power requirements to each element of the device 10. In one embodiment, the batteries can be permanently located within the main body and can be rechargeable in nature via the cable input 24b, for example. Of course, traditional batteries can also be utilized and the main body can further include a battery compartment having a removable cover (not illustrated) for allowing a user to access the same. In another embodiment, a solar panel 27b can be provided so as to provide a charge to the battery when the device is exposed to sunlight.

Finally, a waterproof pocket 28 can be provided along the main body 11 at a location preferably adjacent to the housing 21. The pocket 28 can function to protect and store the users belongings such as the external media device, keys and/or wallet, for example.

Although described above as including a particular number of pockets and/or components located within a particular location, this is for illustrative purposes only, as the towel device can include any number of different pockets and each of the above described components can be positioned within any such pocket. For example, in various embodiments, the device 10 can include the first speaker 25a contained within the housing 21, and three weighted elements 15. Conversely, another embodiment having the first speaker 25a within housing 21 and three additional speakers are also contemplated.

As shown in FIG. 3, a plurality of beach towel devices 10 and 10′ can be communicatively linked via the respective communication units 24 to receive and play music from one or more external media players 5. Moreover, as each corner of the towels are occupied by either a weighted element 15, or a portion of the sound system, the beach towels are not subject to being disturbed by gusts of wind, thereby preventing sand from accumulating along the top surface 11a thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A beach towel, comprising:
a main body having a top surface, a bottom surface, a top end, a bottom end, and a pair of opposing sides, said main body further including four pockets that are disposed along each of a first, second, third and fourth corner;
a pair of weighted elements that are configured to be positioned within the first and second pockets; and
a sound system that is positioned within the third pocket, said sound system including
a communication unit that functions to receive audio signals from an external media player,
a first waterproof speaker that is configured to play the received audio signals;
a control panel that is configured to selectively control the sound system, and
a power source for providing power to the sound system.

2. The towel of claim 1, wherein the top surface of the main body is constructed from a soft absorbent material, and the bottom surface of the main body is constructed from a lightweight waterproof material.

3. The towel of claim 1, wherein each of the pair of weighted elements comprise bean bags having a weight of between 0.25 pounds and 0.75 pounds.

4. The towel of claim 3, wherein the weighted elements are removably secured within the first and second pockets.

5. The towel of claim 3, wherein the weighted elements are permanently secured within the first and second pockets.

6. The towel of claim 1, wherein the communication unit includes a communication cable that is configured to engage the external media device.

7. The towel of claim 1, further comprising:
a cable input device, said device being configured to engage a communication cable from a second towel device, and to transmit the received audio signals thereto.

8. The towel of claim 1, further comprising:
a processor and memory that are communicatively linked within the sound system, said memory including a persistent data storage device that is configured to store the received audio signals.

9. The towel of claim 1, further comprising:
a second waterproof speaker that is communicatively linked to the sound system, said second speaker being positioned within the fourth pocket.

10. The towel of claim 9, wherein the sound system and first speaker are removably secured within the third pocket, and the second speaker is removably secured within the fourth pocket.

11. The towel of claim 9, wherein the sound system and first speaker are permanently secured within the third pocket, and the second speaker is permanently secured within the fourth pocket.

12. The towel of claim 1, further comprising a waterproof pocket that is disposed adjacent to the sound system.

13. The towel of claim 1, further comprising:
a solar panel that is disposed along the top surface of the main body and communicatively linked to the power source.
